(19) United States
(12) Patent Application Publication
(10) Pub. No.: US 2008/0185242 A1
(43) Pub. Date: Aug. 7, 2008

(54) TORQUE BRAKE

(75) Inventors: Edward A. Mayer, West Orange, NJ (US); Arthur I. Degenholtz, Teaneck, NJ (US)

Correspondence Address: PEARNE & GORDON LLP, 1801 EAST 9TH STREET, SUITE 1200, CLEVELAND, OH, 44114-3108, US

(73) Assignee: Curtiss Wright Controls Inc., Gastonia, NC (US)

(21) Appl. No.: 12/024,414

(22) Filed: Feb. 1, 2008

Related U.S. Application Data
(60) Provisional application No. 60/887,689, filed on Feb. 1, 2007.

(51) Int. Cl. B60T 8/72

(52) U.S. Cl. 188/181 T

(57) ABSTRACT

A torque transfer limiting arrangement includes a housing, an input drive shaft, an output drive shaft, and an output cam plate having a plurality of ball ramps with a plurality of balls for transmitting input torque to the output cam plate. A stator assembly is rotatably fixed relative to the housing, and includes at least one stator friction disc. A rotor assembly includes at least one rotor friction disc rotatable relative to the stator friction disc. A sensing spring permits axial displacement of the output cam plate when the input torque exceeds a predetermined maximum limit, whereupon the plurality of balls in the ball ramps cause axial displacement of the output cam to thereby drive the clutch into an engaged state causing relative rotation between the rotor and stator friction discs for isolating and frictionally dissipating the input torque.

### CROSS-REFERENCE TO RELATED APPLICATIONS

This application claims the benefit of U.S. Provisional Application No. 60/887,689, filed Feb. 1, 2007, the entire disclosure of which is hereby incorporated herein by reference.

### FIELD OF THE INVENTION

The present invention relates generally to torque limiting devices, and more particularly, to torque limiting devices with trip indicators.

### BACKGROUND OF THE INVENTION

Torque brakes are typically used in aircraft applications in order to protect an actuator and associated structure from a full stall/dynamic torque applied by power drive source. For example, damage may occur during an excessive torque situation, such as can occur during a lock-up condition. In such a case, the torque brake can interrupt the flow of torque between an input (e.g., a power drive source) and an output (e.g., an actuator). In one example, torque brakes can prevent damage to mechanical transmissions that are used to move control surfaces, and prevent damage to the wing structures. Of course, the invention can be utilized in various systems where a drive unit is to be prevented from exerting excessive torque.

In general, torque limiting devices can operate in severe environments including wide extremes of temperature, altitude, and weather. In addition, torque limiting devices are often used on high performance aircraft where severe vibration also occurs. Aircraft operating in such conditions put high demand loads on the control surfaces and subsequently, the associated actuation system. Accordingly, the need for torque limiting devices is readily apparent.

It is desirable to have a torque limiting device that operates reliably and swiftly. Also, it is desirable to prevent inadvertent lock-outs due to inertia or load spikes. In addition, it is desirable to have a torque limiting device that includes a reduced sensitivity range and reduces the occurrence of low temperature breakout torque penalties. It is also desirable that the size of the actuators used be reduced. Therefore, it can be beneficial to reduce, minimize, or even eliminate torque penalties.

### BRIEF SUMMARY OF THE INVENTION

The following presents a simplified summary of the invention in order to provide a basic understanding of some example aspects of the invention. This summary is not an extensive overview of the invention. Moreover, this summary is not intended to identify critical elements of the invention nor delineate the scope of the invention. The sole purpose of the summary is to present some concepts of the invention in simplified form as a prelude to the more detailed description that is presented later.

In accordance with one aspect of the present invention, a torque transfer limiting arrangement is provided for use with a rotating drive shaft. The torque transfer limiting arrangement includes a housing, an input drive shaft supported for rotation relative to the housing for inputting an input torque, and an output drive shaft for outputting the input torque to a driven component. An input cam plate is operatively coupled to the input drive shaft and including a plurality of ball ramps, and an output cam plate includes a plurality of ball ramps corresponding to the ball ramps of the input cam plate, and is operatively coupled to the output drive shaft. A plurality of balls are adapted to fit within the ball ramps of the cam plates for transmitting the input torque from the input cam plate to the output cam plate. The balls are adapted to displace the output cam plate in an axial direction away from the input cam plate when relative rotation occurs between the input cam and the output cam plate. A sensing spring biases the output cam plate towards the input cam plate so as to locate the plurality of balls in the ball ramps of the cam plates. The sensing spring permits axial displacement of the output cam plate relative to the input cam plate when the input torque exceeds a predetermined maximum limit. A stator assembly is rotatably fixed relative to the housing and includes at least one stator friction disc. A rotor assembly is rotatable relative to the housing and includes at least one rotor friction disc rotatable relative to the stator friction disc. The stator and rotor assemblies have a non-engaged state wherein the at least one rotor disc is generally rotationally stationary relative to the at least one stator disc, and an engaged state wherein the at least one rotor disc rotates relative to the at least one stator disc. A member is rotatable relative to the housing and axially movable relative to the housing, and is coupled to the rotor assembly so as to rotate therewith. A load spring biases the member towards the rotor assembly so as to bias the at least one stator friction disc towards frictional engagement with the at least one rotor friction disc. A clutch includes a first set of clutch teeth coupled to the output cam plate and a second set of clutch teeth coupled to the rotor assembly. The sensing spring biases the first set of clutch teeth towards non-engagement with the second set of clutch teeth until the input torque exceeds the predetermined maximum limit, whereupon the sensing spring permits the plurality of balls in the ball ramps to cause axial displacement of the output cam away from the input cam to thereby drive the first set of clutch teeth into engagement with the second set of clutch teeth to change the stator and rotor assemblies to the engaged state for isolating and frictionally dissipating the input torque.

In accordance with another aspect of the present invention, a torque transfer limiting arrangement is provided for use with a rotating drive shaft. The torque transfer limiting arrangement includes a housing, and an input drive shaft supported for rotation relative to the housing for inputting an input torque, with the input drive shaft including a flange having a plurality of ball ramps. An output drive shaft is provided for outputting the input torque to a driven component, and an output cam plate includes a plurality of ball ramps corresponding to the ball ramps of the flange. The output cam plate is operatively coupled to the output drive shaft by way of a sliding spline. A plurality of balls are adapted to fit within the ball ramps of the flange and output cam plate for transmitting the input torque from the input drive shaft to the output drive shaft, and the balls are adapted to displace the output cam plate in an axial direction away from the flange when relative rotation occurs between the flange and the output cam plate. A sensing spring biases the output cam plate towards the flange so as to locate the plurality of balls in the ball ramps, and permits axial displacement of the output cam plate relative to the flange when the input torque exceeds a predetermined maximum limit. A stator assembly is rotatably fixed relative to the housing and includes a plurality of stator friction discs. A rotor assembly is rotatable relative to the housing and includes a plurality of rotor friction discs rotatable relative to the stator friction discs. A member is rotatable relative to the housing and is axially moveable relative to the housing, and is coupled to the rotor assembly to rotate therewith. A load spring biases the member towards the rotor assembly so as to bias the at stator friction discs towards frictional engagement with the rotor friction discs. A first set of teeth is carried by the output cam plate, and a second set of teeth is carried by the rotor assembly and coaxially aligned with the first set of teeth. The sensing spring biases the first set of teeth towards a disengaged state with the second set of teeth until the input torque exceeds the predetermined maximum limit, whereupon the plurality of balls in the ball ramps cause axial displacement of the output cam away from the flange to thereby drive the first set of teeth into engagement with the second set of teeth causing relative rotation between the rotor and stator friction discs for isolating and frictionally dissipating the input torque.

In accordance with another aspect of the present invention, a torque transfer limiting arrangement is provided for use with a rotating drive shaft. The torque transfer limiting arrangement includes a housing and an input drive shaft supported for rotation relative to the housing for inputting an input torque. The input drive shaft includes a flange having a plurality of ball ramps. An output drive shaft is provided for outputting the input torque to a driven component, and an output cam plate includes a plurality of ball ramps corresponding in location and geometry to the ball ramps of the flange. The output cam plate is operatively coupled to the output drive shaft. A plurality of balls is adapted to fit within the ball ramps of the flange and output cam plate for transmitting the input torque from the input drive shaft to the output drive shaft. The balls are adapted to displace the output cam plate in an axial direction away from the flange when relative rotation occurs between the flange and the output cam plate. A sensing spring biases the output cam plate towards the flange so as to locate the plurality of balls in the ball ramps, and the sensing spring permits axial displacement of the output cam plate relative to the flange when the input torque exceeds a predetermined maximum limit. A stator assembly is rotatably fixed relative to the housing and includes a plurality of stator friction discs. A rotor assembly is rotatable relative to the housing and includes a plurality of rotor friction discs rotatable relative to the stator friction discs. A first set of teeth is carried by the output cam plate, and a second set of teeth is carried by the rotor assembly and is coaxially aligned with the first set of teeth. The sensing spring maintains the first set of teeth in a disengaged state with the second set of teeth until the input torque exceeds the predetermined maximum limit, whereupon the plurality of balls in the ball ramps cause axial displacement of the output cam away from the flange to thereby drive the first set of teeth into engagement with the second set of teeth causing relative rotation between the rotor and stator friction discs for isolating and frictionally dissipating the input torque. A first trip indicator includes a plunger moveable between non-trip and trip positions and biased towards the non-trip position. The axial displacement of the output cam plate away from the flange causes the plunger to move to the trip position.

In accordance with yet another aspect of the present invention, a torque transfer limiting arrangement is provided for use with a rotating drive shaft. The torque transfer limiting arrangement includes a housing, input means for inputting an input torque, output means for outputting the input torque to a driven component, an input cam plate operationally coupled to the input means and including a plurality of ball ramps, and an output cam plate operatively coupled to the output means and including a plurality of ball ramps corresponding to the ball ramps of the input cam plate. A plurality of balls is adapted to fit within the ball ramps of the input and output cam plates for transmitting the input torque from the input means to the output means. The balls are adapted to displace the output cam plate in an axial direction away from the input cam plate when relative rotation occurs between the input and the output cam plates. A friction disc assembly includes a plurality of non-rotating discs and a plurality of rotating discs adapted to frictionally dissipate rotational energy. The torque transfer limiting arrangement also includes means for engaging the output cam plate with the friction disc assembly, and means for resiliently biasing the output cam plate towards the input cam plate and away from the friction disc assembly so as to locate the plurality of balls in the ball ramps and separate the output cam plate a distance from the friction disc assembly. The means for resiliently biasing permits axial displacement of the output cam plate relative to the input cam plate only when the input torque exceeds a predetermined maximum limit, whereupon the output cam plate engages the friction disc assembly via the means for engaging such that the rotating discs will be rotated relative to the non-rotating discs for frictionally dissipating the input torque. The input torque will remain isolated from the output means until the input torque is reduced to a level below the predetermined maximum limit, whereupon the torque transfer limiting arrangement will automatically reset.

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 illustrates a sectional view of an example torque transfer limiting arrangement in accordance with one aspect of the present invention;

FIG. 2 illustrates a sectional, detail view of another example torque transfer arrangement in accordance with another aspect of the present invention;

FIG. 3A is similar to FIG. 2, but shows an example trip indicator;

FIG. 3B is similar to FIG. 3A, but shows another example trip indicator;

FIG. 4 is similar to FIG. 3A, but shows yet another example trip indicator;

FIG. 5A illustrates one example ball ramp geometry in accordance with another aspect of the present invention;

FIG. 5B is similar to FIG. 5A, but illustrates another example ball ramp geometry;

FIG. 6A illustrates a perspective, detail view of an example operation of a trip indicator in accordance with another aspect of the present invention;

FIG. 6B is similar to FIG. 6A, but illustrates another example operation of a trip indicator;

FIG. 6C is similar to FIG. 6A, but illustrates yet another example operation of a trip indicator; and

FIG. 6D is similar to FIG. 6B, but illustrates yet another example operation of a trip indicator.

### DESCRIPTION OF EXAMPLE EMBODIMENTS

Example embodiments that incorporate one or more aspects of the present invention are described and illustrated in the drawings. These illustrated examples are not intended to be a limitation on the present invention. For example, one or more aspects of the present invention can be utilized in other embodiments and even other types of devices. Moreover, certain terminology is used herein for convenience only and is not to be taken as a limitation on the present invention. Still further, in the drawings, the same reference numerals are employed for designating the same elements.

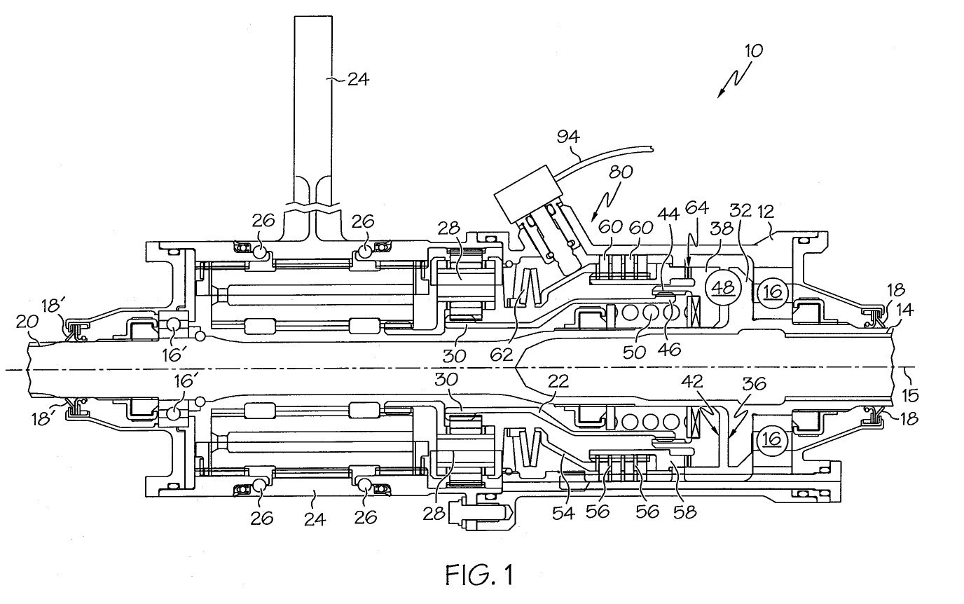

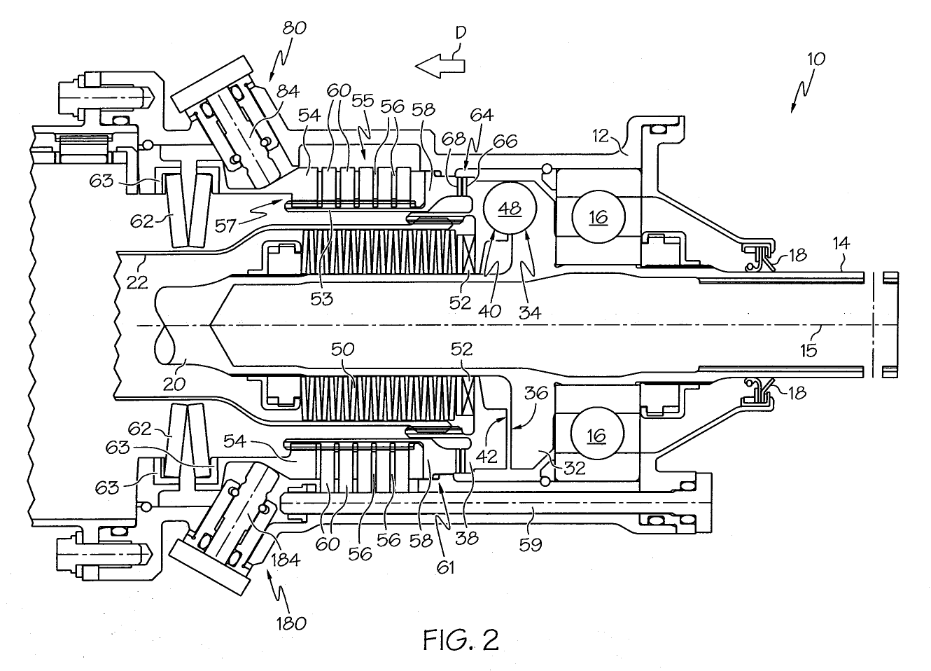

Turning to the shown example of FIGS. 1 and 2, a sectional view of an example torque transfer limiting arrangement 10 is illustrated in accordance with one aspect of the present invention. Similar variants of the arrangement 10 are illustrated in FIGS. 2-4, including similar item numbers. However, it is to be appreciated that for clarity, FIGS. 2-4 are detail views that omit structure located generally downstream from an output drive shaft 22. Still, such omitted structure can be identical, similar, or even different than that shown in FIG. 1.

The arrangement 10 includes a housing 12 that is formed of a generally rigid material (e.g., a metal, plastic, or the like) adapted to be secured to a structure, such as an aircraft frame (not shown) or the like. Though the following description will be illustrated with respect to an example application for use in an aircraft, it is to be appreciated that the arrangement 10 can be utilized in various other applications where a drive unit is to be inhibited or even prevented from exerting excessive torque. Thus, for example, the illustrated example arrangement 10 can be utilized in an actuator for aircraft flight controls, such as trailing edge flap systems, slats, ailerons, rudders, etc.

The arrangement 10 can include an input drive shaft 14 supported for rotation relative to the housing 12, such as by bearings 16, bushings, or the like. The input drive shaft 14 and/or housing 12 can include various shaft seals 18 (e.g., lip seals) or the like. The input drive shaft 14 provides an input torque to the arrangement 10 from a power drive source (not shown) of the aircraft, coupled directly or indirectly thereto. The input drive shaft 14 can provide an input torque to only a single arrangement 10, or alternatively, as shown, can provide the input torque to a plurality of systems, such as a plurality of arrangements (not shown). For example, the input drive shaft 14 can include a through shaft 20 that extends through the arrangement 10 for direct or indirect connection with another system, such as another arrangement 10 or the like. The through shaft 20 can be connected to or even formed with the input drive shaft 14, and can include similar support elements, such as bearings 16′, bushings, shaft seals 18′, etc.

The arrangement 10 can further include an output drive shaft 22 for outputting the input torque to a driven component, such as an actuator arm 24 or the like. The output drive shaft 22 can be supported for rotation relative to the housing 12 in various manners. It is to be appreciated that the driven component can include various driven components adapted to deliver the input torque to various systems. The actuator arm 24, as shown for use in an aircraft system, can be supported for rotation relative to the housing by way of bearings 26, bushings, or the like. The output drive shaft 22 can be directly or indirectly coupled to the driven component 24 in various manners. For example, as shown, the output drive shaft 22 can be indirectly coupled to the driven component 24 by way of gear teeth 30, a sliding spline shaft, or the like coupled to a gear train 28 that can include one or more gears that can transfer the torque with or without modification. For example, the gear train 28 can provide an unmodified torque transfer (e.g., a 1:1 transfer ratio), or can alternatively modify either or both of the rotational speed or torque via various gearing combinations or the like. A clutch system or the like (not shown) can also be provided between the output drive shaft 22 and the driven component 24. In addition or alternatively, it is to be appreciated that the engagement between the gear teeth 30 and the gear train 28 can include a sliding connection that can permit either of the gear teeth 30 and/or gear train 28 to move axially relative to each other.

The arrangement 10 can further include an input cam plate 32 operatively coupled to the input drive shaft 14. In one example, as shown, the input cam plate 32 can be formed with the input drive shaft 14. In another example, the input cam plate 32 can include a flange or the like that is coupled to the input drive shaft 14 in various removable or non-removable manners, including fasteners, welding, adhesives, various mechanical fits (e.g., interference fit, key fit, spline shaft, etc.) or the like. The input cam plate 32 or flange can further include a plurality of ball ramps 34 or detent sockets located on a face surface 36 thereof. For example, as shown, the input cam plate 32 can include three generally similar ball ramps 34 (only one shown) spaced approximately equally on the face surface 36, though various numbers of ball ramps 34 spaced variously on the input cam plate 32 can also be used.

The arrangement 10 can further include an output cam plate 38 including a plurality of ball ramps 40 or detent sockets corresponding to the ball ramps 34 of the input cam plate 32 or flange. The plurality of ball ramps 40 can be located on a face surface 42 of the output cam plate 38. Thus, the plurality of ball ramps 40 can be of generally the same shape, geometry, and/or placement on the output cam plate 38. Still, it is to be appreciated that the plurality of ball ramps 40 on the output cam plate 38 can be of a different number, shape, geometry, and/or placement than those of the input cam plate 32.

The output cam plate 38 can be directly or indirectly coupled to the output drive shaft 22 in various manners for transferring the input torque therebetween. In one example, as shown, the output cam plate 38 can include spline teeth 44, a sliding spline shaft, or the like for engagement with corresponding spline teeth 46, sliding spline shaft or the like of the output drive shaft 22. As will be discussed more fully herein, it is to be appreciated that the engagement between the spline teeth 44, 46 can include a sliding connection that can permit either of the output cam plate 38 and/or output drive shaft 22 to move axially relative to each other.

A plurality of balls 48 can also be provided that are adapted to fit within the ball ramps 34, 40 for transmitting the input torque from the input cam plate 32 or flange to the output cam plate 38. Each of the plurality of balls 48 is located at least partially within a corresponding pair of ball ramps 34, 40 and is interposed between the input cam plate 32 and the output cam plate 38. Thus, as will be generally understood by one of skill in the art, the input torque can be transmitted from the input cam plate 32, through the plurality of balls 48, and to the output cam plate 38. Additionally, as will also be understood by one of skill in the art, the ball ramps 34, 40 can have a geometry such that the balls 48 are adapted to displace the output cam plate 38 in an axial direction away from the input cam plate 32 when relative rotation occurs between the input cam plate 32 and the output cam plate 38. In one example, relative rotation can occur between the input cam plate 32 and the output cam plate 38 during a lock-up condition or the like wherein the input torque supplied by the input cam plate 32 exceeds that which can be received by the driven component 24. For example, the driven component 24 can be in a locked condition or the like and unable to receive additional input torque for various reasons, including damage, blockage, excessive external forces (e.g., excessive aerodynamic forces or the like), etc.

A sensing spring 50 can also be provided to bias the output cam plate 38 towards the input cam plate 32 or flange so as to locate and/or retain the plurality of balls 48 in the ball ramps 34, 40. The sensing spring 50 can include various resilient elements, such as a torsion spring, leaf spring, spiral spring, one or more Belleville washers or springs, etc. formed of various resilient materials, including metals, plastics, etc. The sensing spring 50 can be adapted to permit axial displacement of the output cam plate 38 relative to the input cam plate 32 when the input torque exceeds a predetermined maximum limit. As such, the force provided by the sensing spring 50 can be designed so as to allow the output cam plate 38 and the input cam plate 32 to be axially separated at the predetermined maximum limit of input torque. Thus, the arrangement 10 of the instant invention can be utilized in various applications that each require a different maximum limit by modifying the sensing spring 50 force, such as by replacing the spring with another providing an appropriate, different spring force. The spring 50 can be anchored at one end against a generally static structure, such as a portion of the housing 12, and at the other end directly or indirectly against the output cam plate 38. In addition or alternatively, one or more anti-friction bearings 52 can be located between the sensing spring 50 and the output cam plate 38 so as to reduce the friction between the end of the spring 50 and the output cam plate 38 during operation of the arrangement 10. The anti-friction bearing 52 can also increase the accuracy, consistency, and/or repeatability of the torque sensing function of the sensing spring 50.

In addition to the sensing spring 50, additional forces are present that can resist separate of the input and output cam plates 32, 38. For example, the additional forces can include friction between the spline teeth 44 or spline shaft of the output cam plate 38 and the corresponding spline teeth 46 or spline shaft of the output drive shaft 22. The force increase created by deflection of the sensing spring 50, and/or the friction between the spline teeth 44, 46 (or splines), can act to resist the separation between the input and output cam plates 32, 38. Moreover, the additional forces can include friction between the gear 30 and the gear grain 28. Thus, during normal operation of the arrangement 10, these forces resist the aforedescribed separation to permit the normal input torque to be transmitted from the input drive shaft 14, through the ball ramp members 34, 40, 48 and to the output drive shaft 22.

The arrangement 10 can further include a friction disc assembly for frictionally dissipating rotational energy to a stator assembly 55 that is rotatably secured to the housing 12. The stator assembly 55 further includes at least one stator friction disc 60. In one example, as shown, the stator assembly 55 can include a plurality of stator friction discs 60 coupled thereto. In one example, as shown in FIG. 2, the stator friction discs 60 can be rotatably secured to the housing 12 by way of one or more bolts 59 or the like. For example, each of the stator friction discs 60 can include a hole, U-channel, or the like (not shown) adapted to receive a portion of the bolt 59. Thus, engagement of the bolt 59 with the hole, U-channel, etc. can inhibit or prevent rotation of the stator friction discs 60 relative to the housing 12. However, the hole, U-channel, etc. can still permit axial movement of the stator friction discs 60 relative to the housing 12, as will be discussed more fully herein.

Additionally, the arrangement 10 can further include a corresponding rotor assembly 58 that is rotatable relative to the housing 12, and includes at least one rotor friction disc 56 that is rotatable relative to the at least one stator friction disc 60. In one example, as shown, the rotor assembly 58 can include a plurality of rotor friction discs 56 coupled thereto, with the number of rotor friction discs 56 being generally equal to the number of stator friction discs 60. Still, it is to be appreciated that the rotor assembly 58 can include more or less rotor friction discs 56 than the number of stator friction discs 60.

The stator and/or rotor friction discs 60, 56 can have various geometries and various sizes, and/or various additional features. For example, as shown, both of the stator and rotor friction discs 60, 56 can have a generally circular geometry, through either or both can also have various other geometries. Further, the stator and rotor friction discs 60, 56 can also include various materials and/or features to provide various desired performance characteristics. In one example, the stator and rotor friction discs 60, 56 can be formed of steel that is plated with tin and/or bronze, though either or both can also include various other materials and/or coatings. Additionally, as can be appreciated by one of skill in the art, the number of stator friction discs 60 can be varied to provide various energy-dissipation performance levels. In addition or alternatively, either or both of the stator and rotor friction discs 60, 56 can include surface features, such as various surface grooves, holes, projections, or the like, for inhibiting, preventing, or breaking hydrodynamic forces that may occur between the friction discs 60, 56 during operation. It is to be appreciated that hydrodynamic forces can be created between the friction discs 60, 56 by various liquids, such as oil, grease, or other lubricants, water, etc. that can be trapped therebetween. Thus, as can be appreciated, reducing or minimizing the hydrodynamic forces between the stator and rotor friction discs 60, 56 can permit the discs 60, 56 to be engaged relatively quicker and/or at lower rotational speeds.

In addition or alternatively, the arrangement 10 can further include a load spring 62 or other resilient element adapted to bias the at least one stator friction disc 60 towards frictional engagement with the at least one rotor friction disc 56. The load spring 62 can directly or indirectly bias the friction discs 60, 56 together. In one example, as shown in FIG. 2, the arrangement 10 can include a member 54 that is rotatable relative to the housing 12 and axially movable relative to the housing 12. As shown in FIG. 2, the member 54 can be rotationally coupled to the rotor assembly 58 via a spline arm 53 or the like. Thus, the member 54 and the rotor assembly 58 can each have corresponding spline structure to provide a sliding spline engagement 57 therebetween. Additionally, the sliding spline engagement 57 can permit the member 54 to be axially movable along a longitudinal axis of the arrangement 10 relative to the housing 12 (e.g., along a longitudinal axis 15 of the input drive shaft 14).

As such, the load spring 62 can bias the member 54 along the longitudinal axis of the arrangement 10 towards the rotor assembly 58. In one example, as shown in FIG. 2, the load spring 62 can have one end directly or indirectly coupled to or in abutment with a portion of the housing 12, and the other end directly or indirectly coupled to or in abutment with a portion of the member 54. Thus, the member 54 can bear against either of an adjacent stator or rotor friction disc 60, 56 to bias the friction discs 60, 56 together.

The load spring 62 can include various resilient elements, such as a torsion spring, leaf spring, spiral spring, one or more Belleville washers or springs, etc. formed of various resilient materials, including metals, plastics, etc. As can be appreciated, the load spring 62 can be adjusted and/or replaced to provide a varying biasing force to achieve various performance levels. In one example, where Belleville washers or springs are used, increasing the size and/or number of washers or springs, or even changing the material thereof, can provide an increased biasing force for increasing the frictional engagement between the friction discs 60, 56. For example, altering the biasing force of the load spring 62 can provide increased control of the spacing between the friction discs 60, 56 so as to reduce or eliminate dirt, debris, and/or ice problems, or the like. In addition or alternatively, the load spring 62 can be configured to bear against a relatively low friction spring seat 63 or the like, such as if the member 54 rotates. In yet another example, one or more spacers 61 can be located between the rotor assembly 58 and the housing 12 to provide additional adjustment.

The arrangement 10 can further include a clutch 64 adapted to selectively couple the output cam plate 38 to the rotor assembly 58. As can be appreciated, various types of clutches 64 can be utilized. In one example, the clutch 64 can include a dog clutch having a first set of clutch teeth 66 coupled to the output cam plate 38, and a second set of clutch teeth 68 coupled to the rotor assembly 58. As can be appreciated, the first set of clutch teeth 66 can correspond to the second set of clutch teeth 68 and be coaxially aligned therewith, though either or both of the sets of teeth 66, 68 can also include different numbers and/or types. Moreover, the clutch teeth 66, 68 can include various numbers and/or types of teeth, including spur teeth, helical teeth, and/or bevel teeth, etc. so as to provide various performance characteristics. In addition or alternatively, the teeth 66, 68 can further include a square, “V,” or truncated “V” profile. It is to be appreciated that the clutch can engage upon contact of the teeth 66, 68, though depending upon the amount of excessive force, the faces of the output cam plate 38 and the rotor assembly 58 may even come into face contact to thereby compress the load springs 62.

During normal operation, the input torque will be maintained at an operating speed by load demand. The sensing spring 50 biases the clutch 64 towards a disengaged state until the input torque exceeds the predetermined maximum limit (i.e., as determined by the sensing spring 50), whereupon the sensing spring 50 can permit the plurality of balls 48 in the ball ramps 34, 40 to cause axial displacement of the output cam 38 away from the input cam 32. The clutch 64 is driven into an engaged state (i.e., engagement of the first and second sets of clutch teeth 66, 68) to cause relative rotation between the rotor and stator friction discs 60, 56 to thereby isolate and frictionally dissipate the excess input torque. Thus, as can be appreciated, varying the biasing force provided by the sensing spring 50 can determine when the clutch 64 engages to drive the rotor assembly 58. That is, increasing the biasing force of the sensing spring 50 can cause the clutch 64 to engage only upon the application of a relatively increased input torque, and similarly, decreasing the biasing force causing the clutch 64 to engage upon the application of a relatively decreased input torque.

Therefore, upon operation of the clutch 64, the input torque is frictionally dissipated so as to provide a “soft stop” of the arrangement 10 to thereby inhibit or prevent damage to downstream components, including the driven component 24 and/or any further downstream components that may be directly or indirectly receiving the input torque via the through shaft 20. The “soft stop” is provided via the frictional engagement between the friction discs 60, 56 of the stator and rotor assemblies 55, 58 that dissipates the input torque over time, thereby avoiding a hard or abrupt stop condition. As such, the “soft stop” can increase the useful life of the parts.

Further, it can be appreciated that once the input torque is in equilibrium with the torque being absorbed by the friction discs 60, 56, the drive shaft 14 will stop. Moreover, the input torque will remain isolated from the output means until the direction of the input torque is reversed and reduced to a level below a preselected limit, whereupon the torque transfer limiting arrangement will automatically reset.

In addition or alternatively, the “soft stop” feature can be further enhanced in various manners. In one example, the “soft stop” can be enhanced via adjustment of the load spring 62. As discussed above, the friction discs 60, 56 are biased together by the force of the load spring 62. As such, varying the load spring 62 can vary the speed and/or strength of the “soft stop” feature.

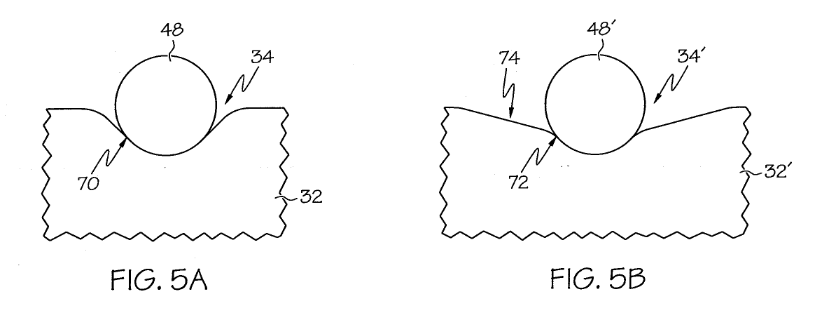

In another example, the “soft stop” can be enhanced via adjustment of the angle of any or all of the ball ramps 34, 40. In one example, reducing or minimizing the angle of the ball ramps 34, 40 can provide an increased or maximum rotation of the ball ramp 34, 40 when the torque brake is tripped to thereby facilitate the action of the cam plates 32, 38 and provide the “soft stop” feature. Turning briefly now to FIGS. 5A-5B, the ball ramps 34, 40 can include various geometries. In a first example, as shown in FIG. 5A, the ball ramps 34, 40 can include a generally continuous angle 70 such that the ball 48 can move a generally continuous amount corresponding to the input torque fluctuations. In a second example, as shown in FIG. 5B, the ball ramps 34′, 40′ (40′ not shown for clarity) can include a portion 72 with a relatively steeper angle 72, and a portion with a relatively shallower angle 74. Thus, as shown, the relatively steeper angle 72 can be the initial angle to thereby reduce the incidence of false trips (e.g., false engagement of the clutch 64) that can be caused by momentary and/or insignificant input torque fluctuations. Further, the relatively shallower angle 74 can increase or maximize the rotation of the output cam plate 38 and rotor assembly 58, which can thereby increase or maximize the rotation of the rotor friction discs 56 relative to the stator friction discs 60 when a jam occurs to increase or maximize the “soft stop” capability. In addition or alternatively, the relatively steeper angle 72 can also permit a relatively smaller and/or lighter sensing spring 50, as compared with a sensing spring that may otherwise be required with a continuous ball ramp angle 70.

Moreover, in addition to providing a “soft stop” feature, the arrangement 10 of the instant application can also provide increased efficiency via a low drag feature. That is, as can be understood from the foregoing description, the rotor friction discs 56 of the rotor assembly 58 only rotate relative to the stator friction discs 60 when the clutch 64 is engaged. As such, in the example shown, the friction discs 60, 56 rotate relative to each other only during an excessive input torque condition. Thus, the frictional losses between the friction discs 60, 56 can be reduced or even eliminated during regular operation of the arrangement (i.e., during normal, non-excessive input torque) because the rotor friction discs 56 are not rotating. In addition or alternatively, as discussed previously herein, the low drag feature can also include the anti-friction bearing 52 located between the sensing spring 50 and the output cam plate 38, though various other anti-friction bearings or the like can also be used to even further reduce friction losses.

In addition or alternatively, the arrangement 10 can further include a trip indicator system 80 to provide users as an indication of a lock-up condition during which the torque brake is and/or was engaged. In one example, where the arrangement 10 is utilized in an aircraft, the trip indicator system 80 can notify a pilot or other flight crew that a lock-up condition is occurring or has occurred so that the matter can be investigated. In another example, the trip indicator system can be utilized to notify a service provider that a lock-up condition previously occurred. The trip indicator system 80 can provide the notification of a lock-up condition using various methods, including mechanical, electrical, chemical, etc. Moreover, where the trip indicator system 80 is used with an electrical system, infrastructure (e.g., mechanical and/or electrical, including analog and/or digital) can be provided for recording and/or logging current and/or historical lock-up conditions, including data provided by various other sensors or the like, for use in diagnostic analysis or the like. Thus, it is to be appreciated that the trip indicator system can be used to provide real-time and/or historical indications of lock-up events.

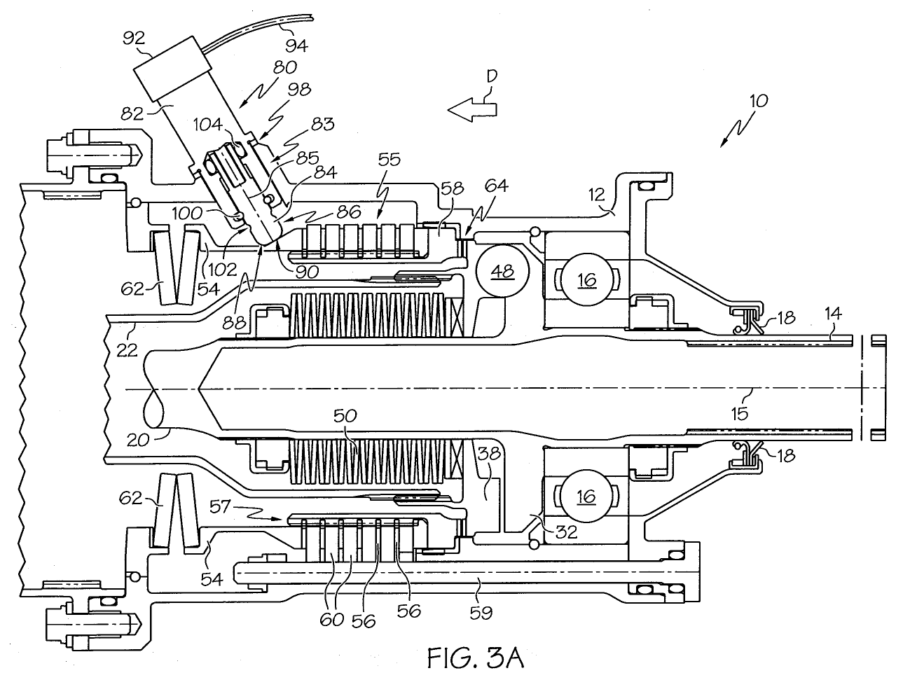

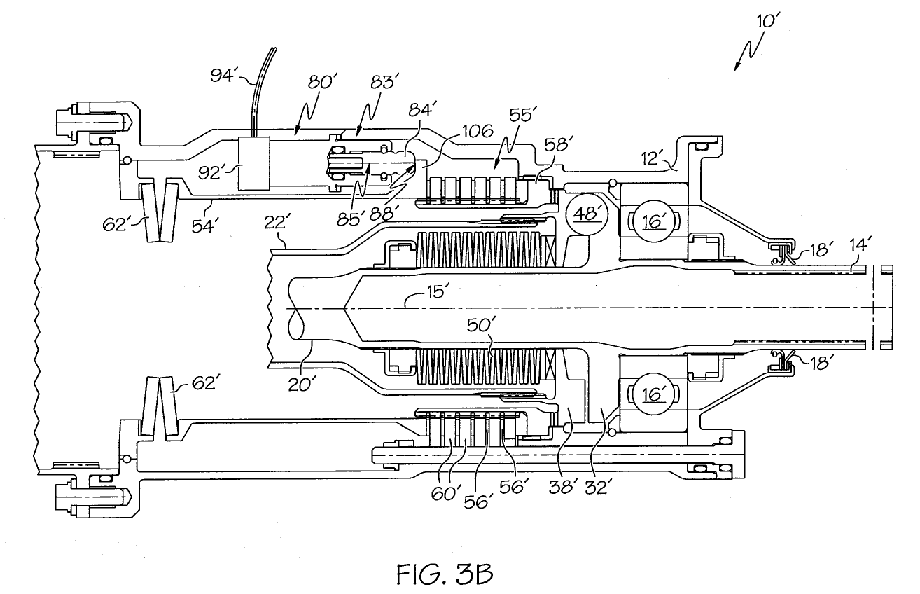

Turning now back to FIGS. 2 and 3A, one example trip indicator system 80 is illustrated for use with the arrangement 10. It is to be appreciated that, for the sake of clarity, the details of the trip indicator system 80 shown in FIG. 3A apply to FIG. 2. As shown, the trip indicator system 80 can include a trip indicator 82 that can be secured to the housing 12 of the arrangement 10 in various manners, such as by way of a threaded screw-type connection 83 between the trip indicator 82 and a correspondingly threaded portion of the housing 12, though various other connections can be used, such as fasteners, adhesives, welding, interference fits, keyed connections, various other mechanical connections, etc. In the example shown, the trip indicator 82 can include a plunger 84 moveable along an axis 85 relative to the remainder of the trip indicator 82 and generally biased towards an extended, non-trip position 86. The plunger 84 can be resiliently biased towards the non-trip position by way of various resilient elements (not illustrated) formed with or coupled to the plunger 84, including various springs or the like. Still, various other actuators aside from a plunger 84 can also be used.

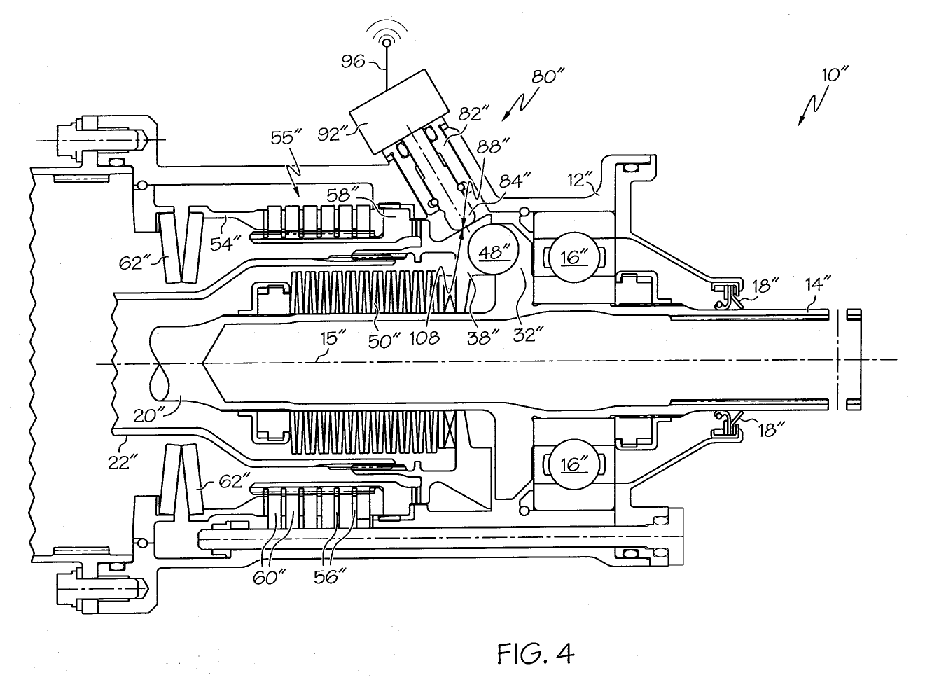

Further, as shown, a distal end 88 of the plunger 84 can be adjacent to or in contact with a generally ramped portion 90 of the member 54. Thus, the plunger 84 can be movable to a trip position (not shown) upon axial displacement of the output cam plate 38 away from the input cam plate 32. That is, as described previously herein, axial displacement of the output cam plate 38 along the direction of arrow D will cause corresponding axial displacement of the rotor assembly 58, stator friction discs 60, and the member 54 along the longitudinal axis, which in turn causes the ramped geometry to slide against the distal end 88 of the plunger 84 and force it inwards relative to the trip indicator 82. Upon being forced inwards, the plunger 84 can actuate a switch 92 or the like to provide an indication of the lock-up condition. In one example, as shown, the switch 92 can be an electrical switch or the like that is actuated by inward movement of the plunger 84. The electrical switch 92 can include various types, including those adapted to make and/or break electrical and/or optical circuits, etc. Moreover, it is to be appreciated that the switch 92 can include contact or non-contact structure, such as a non-contact optical switch, proximity switch, sensor, and/or various other types of switches and/or sensors. The electrical switch 92 can be directly or indirectly coupled in various manners to the aforedescribed infrastructure for indicating, recording and/or logging the lock-up conditions, including by way of electrically conductive cable 94 and/or various wireless technologies, including various radio or microwave communication systems or the like utilizing an antenna 96 or the like (see FIG. 4).

The trip indicator 82 can also include various other elements and/or features. In one example, the trip indicator 82 can include one or more shims 98 or the like located between the trip indicator 82 and the housing 12. The shims 98 can permit adjustment of the spacing between the plunger 84 and the stator assembly 55, and/or the shims 98 can provide a sealing connection between the trip indicator 82 and the housing 12. In another example, the trip indicator 82 can include a spring clip 100 or the like configured to engage a corresponding detent 102 of the plunger 84 for limiting the axial movement of the plunger 84. In yet another example, the trip indicator 82 can include an o-ring 104 or various other sealing structure for providing a sealing connection with the plunger 84 so as to inhibit foreign debris, lubricant, water, or the like from entering the trip indicator 82. Moreover, the aforedescribed spring clip 100 can also be configured to provide a sealing connection. In still yet another example, where the plunger 84 is used with a ramped geometry 90, as described herein, the distal end 88 of the plunger 84 can include a rounded geometry so as to facilitate engagement of the plunger 84 with the ramped geometry 90. It is to be appreciated that the trip indicator 82 can include more or less structure than that described herein. Furthermore, it is to be appreciated that the trip indicator 82 can include structure other than the plunger-based system described, such as various other types of switches, sensors, or the like. For example, the trip indicator 82 can include a proximity sensor (contact or non-contact, not shown) that can detect movement of the stator assembly 55 relative to the housing 12 or other element.

Turning now to the example shown in FIG. 3B, another example trip indicator system 80′ is illustrated. It is to be appreciated that, for brevity, similar or identical elements are referenced by use of a prime (′) designation, and that the trip indicator system 80′ can include more or less elements than the aforedescribed trip indicator system 80. As shown, the trip indicator system 80′ can be located substantially or entirely within the housing 12′ of the arrangement 10′ so as to generally reduce the overall cross-sectional area of the arrangement 10′. As compared to the example illustrated in FIG. 3A, wherein the trip indicator 82 is oriented at an angle of approximately 45 degrees relative to the housing 12 (other angles are also contemplated) thereby requiring relatively more space for the arrangement 10′, the trip indicator 82′ of FIG. 3B is oriented at an angle of approximately 0 degrees. It can be beneficial to generally reduce the overall cross-sectional area of the arrangement 10′ for use in specialized applications, such as for use in aircraft having relatively thin-wing configurations.

As shown, the trip indicator 82′ can be coupled 83′ to the housing 12′ in a similar or different fashion so as to inhibit movement of the trip indicator 82′. Because the trip indicator 82′ is oriented at an angle of approximately 0 degrees (other angles are also contemplated), the housing 12′ of the arrangement 10′ may be lengthened to accommodate the length of the trip indicator 82′, as illustrated, though a trip indicator 82′ having a modified geometry (e.g., relatively smaller, shorter, wider, etc.) can also be utilized. As before, the plunger 84′ can be configured for generally linear movement relative to the trip indicator 82′. However, with the instant configuration, the plunger 84′ can be configured for linear movement along an axis 85′ arranged generally parallel to the longitudinal axis 15′ of the input drive shaft 14′. Thus, in addition or as an alternative to the ramped geometry 90 of FIG. 3A, the member 54′ can include a projection 106 or annular ring extending generally perpendicular thereto and adjacent to or in abutment with the distal end 88′ of the plunger 84′. Thus, upon axial displacement of the member 54′ during a lock-up condition, the projection 106 can force the plunger 84′ linearly inwards along its longitudinal axis to actuate the trip indicator system 80′. Still, various other configurations of the trip indicator 80′ relative to the housing 12′ and/or member 54′ are also contemplated.

Thus, according to the preceding operational descriptions, the trip indicator system 80, 80′ can be adapted to function such that the plunger 84, 84′ is moveable to the trip position only upon axial displacement of the member 54, 54′ away from the input cam plate 32, 32′. However, it is to be appreciated that the trip indicator system 80, 80′ can also be adapted to function in various other manners during a lock-up condition.

Turning now to the example shown in FIG. 4, another example trip indicator system 80″ is illustrated. As before, it is to be appreciated that, for brevity, similar or identical elements are referenced by use of a double prime (″) designation, and that the trip indicator system 80″ can include more or less elements than either of the aforedescribed trip indicator systems 80, 80′ for various reasons, such as for increased reliability or the like. Similar to the previous trip indicator systems 80, 80′, the plunger 84″ of the instant trip indicator system 80″ can be configured to be actuated upon axial displacement of the output cam plate 38″ away from the input cam plate 32″. However, in distinction with either of the previous trip indicator systems 80, 80′, the instant trip indicator system 80″ can be configured to be directly actuated upon axial displacement of the output cam plate 38″.

Thus, as shown in FIG. 4, the trip indicator system 80″ can include the trip indicator 82″ secured to the housing 12″ of the arrangement 10″ so as to locate the plunger 84″ adjacent to the output cam plate 38″. As before, the plunger 84″ can be resiliently biased towards the non-trip position by way of various resilient elements (not shown). The distal end 88″ of the plunger 84″ can be adjacent to or in contact with a generally ramped portion 108 of the output cam plate 38″. Thus, the plunger 84″ can be movable to the trip position (not shown) upon axial displacement of the output cam plate 38″ away from the input cam plate 32″, as will occur during a lock-up condition. That is, as described previously herein, axial displacement of the output cam plate 38″ will cause the ramped geometry 108 to slide against the distal end 88″ of the plunger 84″ and force it inwards relative to the trip indicator 82″ to actuate a switch, sensor, or the like to provide an indication of the lock-up condition. As before, the switch, sensor, etc. can be of a contact or non-contact mechanical, electrical, chemical design, etc. It is to be appreciated that the trip indicator system 80″ can also be located substantially or entirely within the housing 12″ of the arrangement 10″ similar to that described above in connection with FIG. 3B (e.g., oriented at an angle of approximately 0 degrees) so as to generally reduce the overall cross-sectional area of the arrangement 10″. The housing 12″ can be configured correspondingly.

Any or all of the trip indicator systems 80, 80′, 80″ described herein can also be configured for actuation based upon relative rotational motion of the various components of the arrangement 10, 10′, 10″ instead of the aforedescribed axial motion. That is, as described previously herein, the output cam plate 38 will rotate relative to the input cam plate 32 during a lock-up condition. Thus, in one example, the relative rotation of the output cam plate 38 can be used to engage the trip indicator system 180, though it is to be appreciated that the following description can similarly be applied to various other rotational elements that are selectively engaged during a lock-up condition, such as the rotor assembly 58 or other elements.

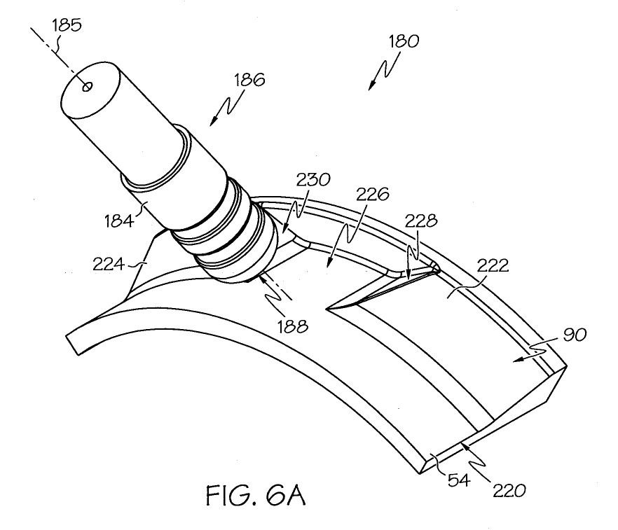

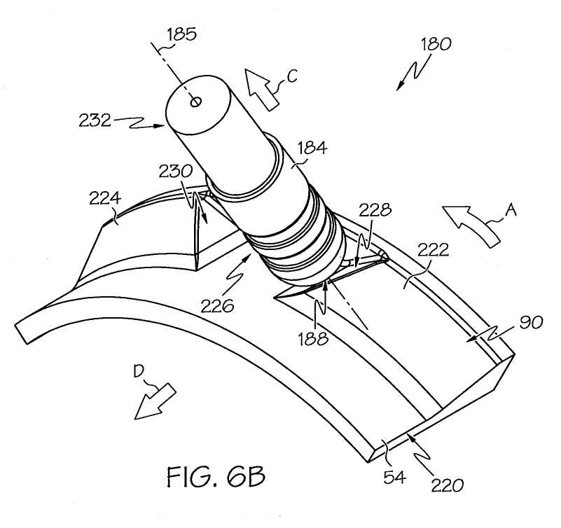

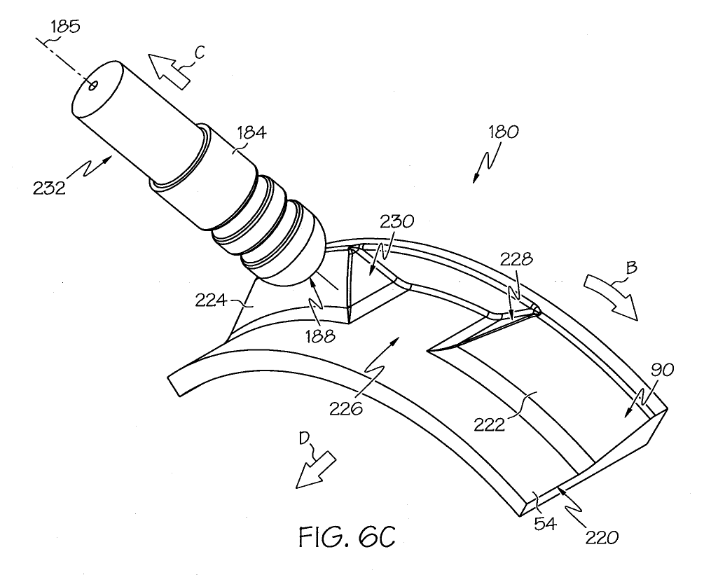

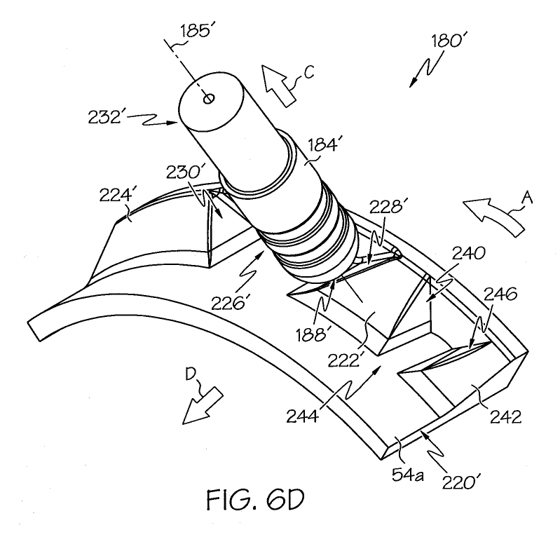

Turning now to the examples shown in FIGS. 2 and 6A-6D, another example trip indicator system 180 will be described. As before, it is to be appreciated that, for brevity, similar or identical elements are referenced by use of a one hundred series designation (e.g., 180, etc.), and that the trip indicator system 180 can include more or less elements than either of the aforedescribed trip indicator systems 80, 80′, 80″. Additionally, though various elements may not be specifically identified with a reference number in FIG. 2, such reference numbers can be readily seen in the detail view of FIG. 3A. Moreover, though the trip indicator system 180 is illustrated in FIG. 2 as being located at a different location than the previous trip indicator systems 80, 80′, 80″, it is to be appreciated that the instant trip indicator system 180 can be located variously and used in addition or as an alternative to any of the previous trip indicator systems 80, 80′, 80″. Furthermore, FIGS. 6A-6D illustrate detail views of the member 54, and as such various elements have not been shown for the sake of brevity, though any of the various elements described herein (or even different elements) can be utilized with the trip indicator system 180. Further still, it is to be appreciated that the trip indicator system 180 can be secured to the housing 12, as shown in FIG. 2 and as described previously herein.

Thus, in one example, the relative rotation of the member 54 can be used to engage the trip indicator system 180. As shown in FIG. 6A, an outer peripheral edge 220 of the member 54 can include one or more cams, such as a first cam 222 and a second cam 224. As shown, the first and second cams 222, 224 are two separate cams separated a distance by a gap 226, though alternatively the cams can include a single element having a recess or the like providing a distinction between two portions thereof to define the two cams. Additionally, the plunger 184 can be resiliently biased towards engagement with the first and second cams 222, 224 by various resilient elements (not shown). Moreover, each of the first and second cams 222, 224 can include corresponding first and second ramped portions 228, 230 to facilitate engagement with the plunger 184, as will be described more fully herein.

During a non-trip condition (e.g., during normal operation), the plunger 184 can be biased towards the gap 226 or recess in a non-trip position 186 (e.g., the centerline 185 of the plunger 184 is shown located within the gap 226 or recess.) Additionally, the plunger 184 may or may not be in contact with the member 54.

During a trip condition (e.g., a lock-up condition), as shown in FIG. 6B, the member 54 can rotate relative to the plunger 184 in a counter-clockwise manner along the direction of arrow A, and may translate along the direction of arrow D, thereby indicating that the torque brake has locked-up as a result of excessive input torque applied in the counter-clockwise direction. The first cam 222 has similarly translated in a counter-clockwise manner relative to the plunger 184 (e.g., the trip indicator 180 remains relatively fixed via its securement to the housing 12) such that the distal end 188 of the plunger 184 rides up on the first cam 222 via the first cam ramped portion 228. As a result, the plunger 184 is moved to the trip position 232 along the direction of arrow C and actuates the aforedescribed switch, sensor, or the like to indicate a lock-up condition. When the excessive input torque decreases or is no longer applied, the torque brake will automatically reset (as previously described herein). Thus, the member 54 will rotate in a clockwise manner so as to locate the distal end 188 of the plunger 184 back into the gap 226 or recess and the non-trip position 186 (see FIG. 6A).

In a similar manner, as shown in FIG. 6C, a trip condition is illustrated wherein excessive input torque is applied in a clockwise direction, the member 54 can rotate relative to the plunger 184 in a clockwise manner along the direction of arrow B, and may translate along the direction of arrow D. As before, the second cam 224 will similarly translate in a clockwise manner relative to the plunger 184 such that the distal end 188 of the plunger 184 rides up on the second cam 224 via the second cam ramped portion 230. As a result, the plunger 184 is moved to the trip position 232′ along the direction of arrow C and actuates the aforedescribed switch, sensor, or the like to indicate a lock-up condition.

The first and second cams 222, 224 can also include various additional structure or features. For example, as described previously herein, either or both of the first and second cams 222, 224 can include the ramped geometry 90 for actuating the plunger 184 during axial displacement of the member 54. In another example, though not shown, either or both of the cams 222, 224 can include detents so as to guide and/or limit the range of motion of either of the plunger 184 and/or member 54. In still yet another example, either or both of the cams 222, 224 can include continuous or varied ramp or slope geometries for the first and second ramped portions 228, 230. For example, either or both of the first and second ramped portions 228, 230 can include increasing or decreasing ramped geometries that can operate in cooperation with a progressive switch or sensor operable over a range that can provide an indication of the degree or severity of the lock-up condition (e.g., a relatively greater plunger 184 movement can indicate a relatively more severe lock-up condition, while a relatively lesser plunger 184 movement can indicate a relatively milder or even transient lock-up condition).

While the aforedescribed trip indicator systems 180 of FIGS. 6A-6C will indicate a trip condition, it can be beneficial to further indicate and distinguish between the clockwise and counter-clockwise trip directions. Such additional information can be beneficial in diagnostic, maintenance, repair, and/or determination of the cause of the lock-up condition of the torque limiting arrangement 10. In one example, as shown in FIG. 2, the arrangement 10 can include two or more trip indicator systems 80, 180 that can be identical, similar, or even different. Though shown located at generally opposite positions, it is to be appreciated that the trip indicator systems 80, 180 can be located variously about the arrangement 10. Each of the multiple trip indicator systems 80, 180 can be adapted to operate with similar cam structure (e.g., cams 222, 224).

Thus, in one example, during a counter-clockwise lock-up condition with respect to the member 54, a first of the trip indicator systems 80″ can be engaged with a respective one of the cams 222, 224, while a second of the trip indicator systems 180 remains disengaged with a respective one of the cams 222, 224 (e.g., the second plunger 84, 184 does not move, or does not move enough to actuate the integrated switch or sensor). Conversely, during a clockwise lock-up condition with respect to the member 54, the second of the trip indicator systems 180 can be engaged with a respective one of the cams 222, 224, while the first trip indicator system 180 remains disengaged with a respective one of the cams 222, 224. Thus, by noting which trip indicator system 80, 180 was engaged and which was disengaged, it is possible to determine the direction of the trip condition. As before, it is to be appreciated that the trip indicator system 180 can be coupled to appropriate infrastructure for recording both the trip indication and the trip direction.

In addition or alternatively, various modifications can be made to the structure of the member 54 to facilitate distinguishing between the engaged and disengaged states of the multiple trip indicator systems 80, 180. In one example, the plunger 84, 184 and/or the gap 226 or recess can be relatively offset relative to each other. In another example, the gap 226 or recess can be enlarged or lengthened. Thus, in either of the foregoing examples, during rotation of the member 54 in one direction (e.g., counter-clockwise) the plunger 84, 184 will engage the first cam 222 as previously described. However, during rotation of the member 54 in the opposite direction (e.g., clockwise), the offset distance of the plunger 84, 184 or the enlarged gap 226 will keep the plunger 84, 184 within the boundaries of the gap 226 or recess to thereby inhibit or prevent engagement of the distal end 88, 188 with a respective cam 222, 224. It is to be appreciated that while at least two separate trip indicator systems 80, 180 are illustrated located at separate locations with separate cam systems, both indicator systems 80, 180 can also be arranged in an adjacent fashion so as to utilize the same cam system.

As a result, the various plungers 84, 184 can be selectively engaged or disengaged based upon the rotational direction of the member 54 such that only one of the plurality of plungers 84, 184 can be engaged upon rotation of the member 54 in one direction. In one example, as shown in FIG. 2, two plungers 84, 184 can be arranged in a diametrically opposed design, though various other relative arrangements (e.g., various other spacing distances, angular adjustments, etc.) of the plungers 84, 184 are also contemplated. Moreover, both of the plungers 84, 184 can include either or both of an offset plunger 84, 184 design or enlarged gap 226 or recess.

In addition or alternatively, while each of the foregoing examples describe distinguishing rotation of the member 54 by utilizing a plurality of trip indicator systems 80, 180, a single trip indicator system having a single plunger can also be utilized. In one example, as shown in FIG. 6D, a single trip indicator system 180′ can be utilized. It is to be appreciated that, for brevity, similar or identical elements are referenced by use of a prime (′) designation, and that the trip indicator system 180′ can include more or less elements than the aforedescribed trip indicator system 180. As shown, a single plunger 184′ can be configured to actuate in a pulse pattern or the like to indicate the rotational direction of the lock-up condition. For example, a plurality of cams 222′, 242 can be arranged with one or more gaps 244 therebetween such that upon rotation of the member 54a in one direction (e.g., counter-clockwise along the direction of arrow A), the plunger 184′ will be actuated first by one cam 222′, released by the gap 244 or recess, and then re-actuated by a second adjacent cam 242. Thus, an electrical (or mechanical, chemical, etc.) signal provided by the trip indicator system 180′ will be pulsed by the arrangement of the various cams 222′, 242 and gap(s) 244. Various types of infrastructure, such as electronics, computers, etc. can be adapted to receive and/or analyze the electrical pulse patterns provided by the trip indicator system 180′ to determine the rotational direction of the lock-up condition. In one example, as shown in FIG. 6D, where only a single electrical pulse is provided by the trip indicator system 180′ for a given time period, a rotational trip direction in the clockwise direction would be indicated as the plunger 184′ would only have been actuated by the single cam 224′. However, where two successive electrical pulses are provided by the trip indicator system 180′ for the same given time period, a rotation trip direction in the counter-clockwise direction would be indicated as the plunger 184′ would have been actuated first by the first cam 222′, released by the gap 244 or recess, and then re-actuated by the second adjacent cam 242. It is to be appreciated that while only one pulse example has been described herein, various other pulse patterns, gaps, etc. can be utilized to indicate the lock-up direction. Moreover, various other pulse patterns, gaps, etc. can indicate various other information, such as velocity and/or acceleration, degree or severity, and/or time duration of the lock-up condition, etc.

Still other arrangements of a single trip indicator system 180′ can be utilized to indicate the rotational direction of a lock-up condition (or various other information). In another example, a single trip indicator system 180′ having a single plunger 184′ can include a plurality of micro-switches or one or more progressive switches (neither shown). Further, the cams on either side of the gap or recess can have different overall heights (not shown). Thus, upon a lock-up condition in the clockwise direction, a first cam could raise the plunger 184′ a first distance, thereby actuating the first micro-switch to indicate the clockwise direction. Similarly, upon a lock-up condition in the counter-clockwise direction, a second cam could raise the plunger 184′ a second, relatively higher distance thereby actuating the second micro-switch (or even both of the first and second micro-switches or progressive switch) to indicate the counter-clockwise direction. It is to be appreciated that various other arrangements are also contemplated to indicate the rotational direction of a lock-up condition (or various other information) by utilizing only a single trip indicator system 180′.

The invention has been described with reference to the example embodiments described above. Modifications and alterations will occur to others upon a reading and understanding of this specification. Examples embodiments incorporating one or more aspects of the invention are intended to include all such modifications and alterations insofar as they come within the scope of the appended claims.

What is claimed is:

1. A torque transfer limiting arrangement for use with a rotating drive shaft, including:
a housing;
an input drive shaft supported for rotation relative to the housing for inputting an input torque;
an output drive shaft for outputting the input torque to a driven component;
an input cam plate operatively coupled to the input drive shaft and including a plurality of ball ramps;
an output cam plate including a plurality of ball ramps corresponding to the ball ramps of the input cam plate, the output cam plate being operatively coupled to the output drive shaft;
a plurality of balls adapted to fit within the ball ramps of the cam plates for transmitting the input torque from the input cam plate to the output cam plate, the balls being adapted to displace the output cam plate in an axial direction away from the input cam plate when relative rotation occurs between the input cam plate and the output cam plate;
a sensing spring biasing the output cam plate towards the input cam plate so as to locate the plurality of balls in the ball ramps of the cam plates, the sensing spring permitting axial displacement of the output cam plate relative to the input cam plate when the input torque exceeds a predetermined maximum limit;
a stator assembly rotatably fixed relative to the housing and including at least one stator friction disc;
a rotor assembly rotatable relative to the housing and including at least one rotor friction disc rotatable relative to the stator friction disc, the stator and rotor assemblies having a non-engaged state wherein the at least one rotor disc is generally rotationally stationary relative to the at least one stator disc, and an engaged state wherein the at least one rotor disc rotates relative to the at least one stator disc;
a member rotatable relative to the housing and axially moveable relative to the housing, the member being coupled to the rotor assembly to rotate therewith;
a load spring biasing the member towards the rotor assembly so as to bias the at least one stator friction disc towards frictional engagement with the at least one rotor friction disc; and
a clutch including a first set of clutch teeth coupled to the output cam plate and a second set of clutch teeth coupled to the rotor assembly, the sensing spring biasing the first set of clutch teeth towards non-engagement with the second set of clutch teeth until the input torque exceeds the predetermined maximum limit, whereupon the sensing spring permits the plurality of balls in the ball ramps to cause axial displacement of the output cam away from the input cam to thereby drive the first set of clutch teeth into engagement with the second set of clutch teeth to change the stator and rotor assemblies to the engaged state for isolating and frictionally dissipating the input torque.

2. The torque transfer limiting arrangement of claim 1, wherein the input torque will be isolated from the output drive shaft until the input torque is reduced to a level below the predetermined maximum limit, whereupon the torque transfer limiting arrangement will automatically reset to change the stator and rotor assemblies back to the non-engaged state.

3. The torque transfer limiting arrangement of claim 1, wherein the rotor assembly rotates relative to the stator assembly only when the clutch is in an actuated state.

4. The torque transfer limiting arrangement of claim 1, wherein at least one of the stator friction disc and the rotor friction disc includes a face having surface grooves adapted to inhibit hydrodynamic forces between the friction discs.

5. The torque transfer limiting arrangement of claim 1, wherein a bearing is located between the sensing spring and the output cam plate.

6. The torque transfer limiting arrangement of claim 1, further including a first trip indicator including a plunger biased towards a non-trip position, the plunger being moveable to a trip position upon axial displacement of the output cam plate away from the input cam plate.

7. The torque transfer limiting arrangement of claim 6, wherein the plunger is moveable to a trip position only upon axial displacement of the member away from the input cam plate.

8. The torque transfer limiting arrangement of claim 6, further including a second trip indicator having a plunger biased towards a non-trip position, the plunger of the first trip indicator being moveable to a trip position only upon axial displacement of the output cam plate away from the input cam plate and clockwise rotation of the member, and the plunger of the second trip indicator being moveable to a trip position only upon axial displacement of the output cam plate away from the input cam plate and counter-clockwise rotation of the member.

9. The torque transfer limiting arrangement of claim 6, wherein the plunger is configured for linear movement along an axis generally parallel to a longitudinal axis of the drive shaft.

10. The torque transfer limiting arrangement of claim 6, wherein the member further includes at least a first cam and a second cam separated by at least one gap, the plunger of the first trip indicator being successively moveable between the trip and non-trip positions by successive engagement with the first cam, the at least one gap, and the second cam during axial displacement of the output cam plate away from the input cam plate and rotation of the member relative to the plunger along a single rotational direction.

11. The torque transfer limiting arrangement of claim 1, wherein the plurality of ball ramps include a geometry having a relatively steep initial angle followed by a relatively shallow angle.

12. A torque transfer limiting arrangement for use with a rotating drive shaft, including:
a housing;
an input drive shaft supported for rotation relative to the housing for inputting an input torque, the input drive shaft including a flange having a plurality of ball ramps;
an output drive shaft for outputting the input torque to a driven component;
an output cam plate including a plurality of ball ramps corresponding to the ball ramps of the flange, the output cam plate being operatively coupled to the output drive shaft by way of a sliding spline;
a plurality of balls adapted to fit within the ball ramps of the flange and output cam plate for transmitting the input torque from the input drive shaft to the output drive shaft, the balls being adapted to displace the output cam plate in an axial direction away from the flange when relative rotation occurs between the flange and the output cam plate;
a sensing spring biasing the output cam plate towards the flange so as to locate the plurality of balls in the ball ramps, the sensing spring permitting axial displacement of the output cam plate relative to the flange when the input torque exceeds a predetermined maximum limit;
a stator assembly rotatably fixed relative to the housing and including a plurality of stator friction discs;
a rotor assembly rotatable relative to the housing and including a plurality of rotor friction discs rotatable relative to the stator friction discs;
a member rotatable relative to the housing and axially moveable relative to the housing, the member being coupled to the rotor assembly to rotate therewith;
a load spring biasing the member towards the rotor assembly so as to bias the at stator friction discs towards frictional engagement with the rotor friction discs;
a first set of teeth carried by the output cam plate; and
a second set of teeth carried by the rotor assembly and coaxially aligned with the first set of teeth,
wherein the sensing spring biases the first set of teeth towards a disengaged state with the second set of teeth until the input torque exceeds the predetermined maximum limit, whereupon the plurality of balls in the ball ramps cause axial displacement of the output cam away from the flange to thereby drive the first set of teeth into engagement with the second set of teeth causing relative rotation between the rotor and stator friction discs for isolating and frictionally dissipating the input torque.

13. The torque transfer limiting arrangement of claim 12, wherein the input torque will be isolated from the output drive shaft until input torque is reduced to a level below the predetermined maximum limit, whereupon the sensing spring will automatically disengage the first set of teeth from the second set of teeth.

14. The torque transfer limiting arrangement of claim 12, wherein the rotor assembly rotates relative to the stator assembly only when the first set of teeth are engaged with the second set of teeth.

15. The torque transfer limiting arrangement of claim 12, wherein at least one of the stator friction discs and the rotor friction discs includes a face having surface features adapted to inhibit hydrodynamic forces between the friction discs.

16. The torque transfer limiting arrangement of claim 12, further including a first trip indicator including a plunger biased towards a non-trip position, the plunger being moveable to a trip position upon axial displacement of the output cam plate away from the flange.

17. The torque transfer limiting arrangement of claim 12, wherein the plurality of ball ramps include a geometry having a relatively steep initial angle followed by a relatively shallow angle.

18. A torque transfer limiting arrangement for use with a rotating drive shaft, including:
a housing;
an input drive shaft supported for rotation relative to the housing for inputting an input torque, the input drive shaft including a flange having a plurality of ball ramps;
an output drive shaft for outputting the input torque to a driven component;
an output cam plate including a plurality of ball ramps corresponding in location and geometry to the ball ramps of the flange, the output cam plate being operatively coupled to the output drive shaft;
a plurality of balls adapted to fit within the ball ramps of the flange and output cam plate for transmitting the input torque from the input drive shaft to the output drive shaft, the balls being adapted to displace the output cam plate in an axial direction away from the flange when relative rotation occurs between the flange and the output cam plate;
a sensing spring biasing the output cam plate towards the flange so as to locate the plurality of balls in the ball ramps, the sensing spring permitting axial displacement of the output cam plate relative to the flange when the input torque exceeds a predetermined maximum limit;
a stator assembly rotatably fixed relative to the housing and including a plurality of stator friction discs;
a rotor assembly rotatable relative to the housing and including a plurality of rotor friction discs rotatable relative to the stator friction discs;
a first set of teeth carried by the output cam plate;
a second set of teeth carried by the rotor assembly and coaxially aligned with the first set of teeth,
wherein the sensing spring maintains the first set of teeth in a disengaged state with the second set of teeth until the input torque exceeds the predetermined maximum limit, whereupon the plurality of balls in the ball ramps cause axial displacement of the output cam away from the flange to thereby drive the first set of teeth into engagement with the second set of teeth causing relative rotation between the rotor and stator friction discs for isolating and frictionally dissipating the input torque; and
a first trip indicator including a plunger moveable between non-trip and trip positions and biased towards the non-trip position, the axial displacement of the output cam plate away from the flange causing the plunger to move to the trip position.

19. The torque transfer limiting arrangement of claim 18, further including:
a member rotatable relative to the housing and axially moveable relative to the housing, the member being coupled to the rotor assembly to rotate therewith; and
a load spring that biases the member towards the rotor assembly so as to bias the at stator friction discs towards frictional engagement with the rotor friction discs.

20. The torque transfer limiting arrangement of claim 19, wherein the member includes a ramped geometry and a portion of the plunger rides upon the ramped geometry, the plunger being moveable to the trip position by the ramped geometry upon axial displacement of the member away from the flange.

21. The torque transfer limiting arrangement of claim 19, further including a second trip indicator having a plunger biased towards a non-trip position, the plunger of the first trip indicator being moveable to a trip position only upon axial displacement of the output cam plate away from the flange and clockwise rotation of the member, and the plunger of the second trip indicator being moveable to a trip position only upon axial displacement of the output cam plate away from the flange and counter-clockwise rotation of the member.

22. The torque transfer limiting arrangement of claim 18, wherein the first trip indicator is adapted to transmit a signal indicative of the trip position when the plunger is moved to the trip position.

23. A torque transfer limiting arrangement for use with a rotating drive shaft, including:
a housing;
input means for inputting an input torque;
output means for outputting the input torque to a driven component;
an input cam plate operationally coupled to the input means and including a plurality of ball ramps;
an output cam plate operatively coupled to the output means and including a plurality of ball ramps corresponding to the ball ramps of the input cam plate;
a plurality of balls adapted to fit within the ball ramps of the input and output cam plates for transmitting the input torque from the input means to the output means, the balls being adapted to displace the output cam plate in an axial direction away from the input cam plate when relative rotation occurs between the input and the output cam plates;
a friction disc assembly including a plurality of non-rotating discs and a plurality of rotating discs adapted to frictionally dissipate rotational energy;
means for engaging the output cam plate with the friction disc assembly; and
means for resiliently biasing the output cam plate towards the input cam plate and away from the friction disc assembly, so as to locate the plurality of balls in the ball ramps and separate the output cam plate a distance from the friction disc assembly,
wherein the means for resiliently biasing permits axial displacement of the output cam plate relative to the input cam plate only when the input torque exceeds a predetermined maximum limit, whereupon the output cam plate engages the friction disc assembly via the means for engaging such that the rotating discs will be rotated relative to the non-rotating discs for frictionally dissipating the input torque, and the input torque will remain isolated from the output means until the input torque is reduced to a level below the predetermined maximum limit, whereupon the torque transfer limiting arrangement will automatically reset.

24. The torque transfer limiting arrangement of claim 23, wherein the friction disc assembly includes:
a stator assembly rotatably fixed relative to the housing and including the plurality of non-rotating discs;
a rotor assembly rotatable relative to the housing and including the plurality of rotating discs frictionally rotatable relative to the non-rotating friction discs;
a member rotatable relative to the housing and axially moveable relative to the housing, the member being coupled to the rotor assembly to rotate therewith; and
a load spring biasing the member towards the rotor assembly so as to bias the at non-rotating friction discs towards frictional engagement with the rotating friction discs.

25. The torque transfer limiting arrangement of claim 23, wherein the means for engaging the output cam plate with the means for dissipating includes:
a first set of teeth carried by the output cam plate; and
a second set of teeth carried by the friction disc assembly and coaxially aligned with the first set of teeth for engagement therewith.

26. The torque transfer limiting arrangement of claim 23, wherein the means for resilient biasing includes at least one spring.

27. The torque transfer limiting arrangement of claim 23, further including means for indicating a trip condition when the output cam plate is axially displaced away from the flange.
